(19) United States
(12) Patent Application Publication
(10) Pub. No.: US 2012/0246895 A1
(43) Pub. Date: Oct. 4, 2012

(54) Belt Binder Structure

(76) Inventor: Fan Ren Lee, Dong Guang (CN)

(21) Appl. No.: 13/073,733

(22) Filed: Mar. 28, 2011

(51) Int. Cl. B25B 25/00

(52) U.S. Cl. 24/68 E

(57) ABSTRACT

An improved belt binder structure having a binder body with a flat base and the two sides bended upward to form side panels that constitute a a binder body with a flat base with two sides bended upward to form an enclosure space for enclosing a reel, a ratchet wheel, a handle, a locking plate and a control pulling plate attached to the two side panels of the handle and can move up and down by the connecting points, and whereas the frontal portion of the control pulling plate has locking structure that locks with the positioning slot on the flat base and the bottom of the plate engages with the ratchet wheels.

### BACKGROUND OF THE INVENTION

(1) Field of the Invention

The invention involves belt binder field of technology, especially a belt binder with an improved structure.

(2) Description of Related Art

Belt binders are widely used for securing heavy loads of goods. A belt binder may come in many form and structure. A typical belt binder may comprises a binder body, a handle, a ratchet wheel, a reel, a belt, a locking plate, and a control pulling plate. Wherein, the belt is attached to the reel and through the movement of the handle and ratchet wheel to tighten or loosen the belt. In this type of belt binder the user needs to press and hold the control pulling plate while push forward on the handle in order to disengage the locking on the ratchet wheel to loosen the belt from the reel. In this sort of operation the user's hand may experience sort and pain and become weary from constant operation of the belt binder.

### SUMMARY OF THE INVENTION

The objective of present invention is to provide an improved belt binder structure to overcome the above-described shortcoming of current belt binders. In order to achieve this objective present invention provides a new type of belt binder with a simpler structure and easier operation.

To accomplish the above objective, present invention provides an improved belt binder structure comprises:

a binder body with a flat base with two sides bended upward to form an enclosure space;

a reel that installed onto the reel holes on the two sides of the flat base;

a ratchet wheel attached to each side end of the reel;

a handle installed over the binder body and where the two side panel of the handle connects to the two side end of the reel;

a locking plate installed in between the two sides of the flat base and to the rear of the reel; the clamp plate engages with the ratchet wheels; and

a control pulling plate attached to the two side panels of the handle and can move up and down by the connecting points, and whereas the frontal portion of the control pulling plate has locking structure that locks with the positioning slot on the flat base and the bottom of the plate engages with the ratchet wheels.

As a preferred technical embodiment, the two side panels are removable from the handle.

As another preferred technical embodiment, the side panels of the handle are provides with decorating panels.

The advantage of above-described belt binder structure is that: to release the lock on the ratchet wheels the user may simply press and hold the control pulling plate.

### BRIEF DESCRIPTION OF THE DRAWINGS

FIG. 1 is an illustration of disembodiment of an improved belt binder structure;

FIG. 2 is an illustration an improved belt binder structure in unlocking position; and

FIG. 3 is an illustration an improved belt binder structure in locking position.

### DETAILED DESCRIPTION OF THE INVENTION

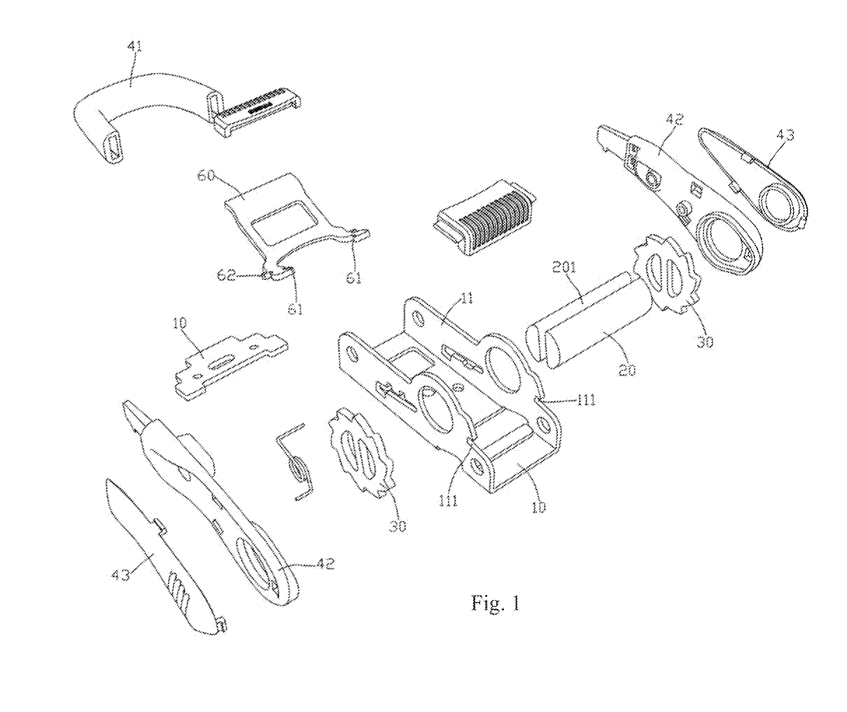

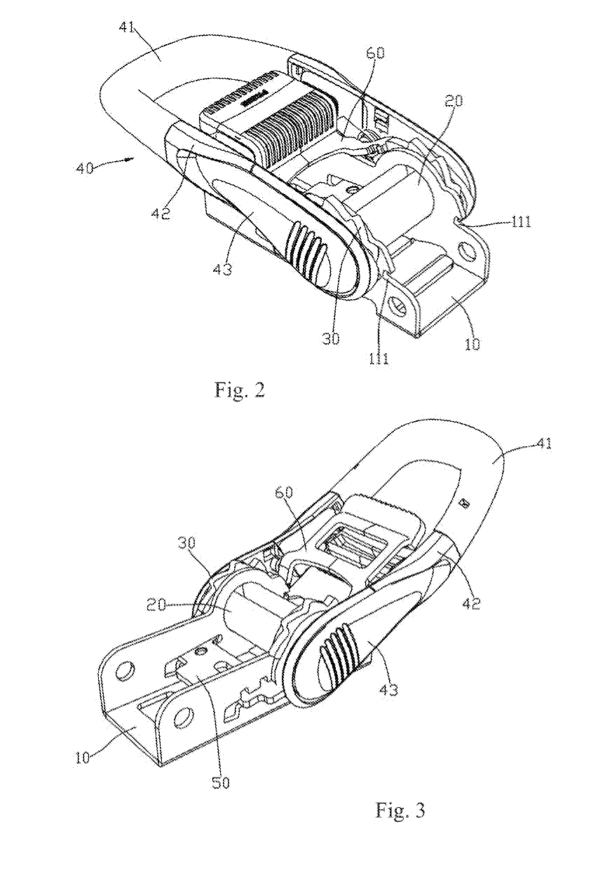

As shown in FIG. 1˜3, an improved belt binder structure comprises a binder body 10, a reel 20, two ratchet wheels 30, a handle 40, a locking plate 50, a control pulling plate 60 and a belt (not shown in the figures).

Whereas, the binder body is provided with a flat base and the two sides of the base are bended upward to form enclosure side panels 11. Whereas, the enclosure side panels 11 are provided with a reel hole 45.

Whereas, the reel 20 is installed onto the binder body 10 by inserting it into the reel holes 45 on the enclosure side panels 11. Whereas, a portion of the installed reel 20 protrudes out from the reel holes 45 of the enclosure side panels 11. Whereas, the reel 20 is provided with a belt slot 201 for receiving and securing the belt.

Whereas, the ratchet wheels 30 maybe installed onto the binder body 10 at the outer (or at the inner) side of the enclosure side panels 11. The ratchet wheels 30 are each slipped and secured onto the two side ends of reel 20 such that ratchet wheel 30 and reel 20 turns simultaneously.

Whereas, the handle 40 is installed over the binder body 10. Whereas, the handle 40 comprises a removable handle bar 41 and side panels 42. To provide aesthetic look, the side panels 42 are provided with decorating panels 43. Furthermore, the side panels 42 are connects with the two side ends of the reel 20 and the side panels can move upward and downward at the connecting points with the reel 20.

Whereas, the locking plate 50 is installed in between the enclosure side panels 11 of the binder body 10 and to the rear of the reel 20. Whereas, the front portion of the locking plate 50 engages with the ratchet wheels 30 preventing them from turning.

Whereas, the control pulling plate 60 is installed in between the side panels 42 of the handle 40. Whereas, the front portion of control pulling plate 60 recesses inward to form a “U” shape frontal portion and whereas the tips of “U” shape frontal portion is provided with locking portions 61 that locks with positioning slot 111 on the side panels 11 of binder body 10 and engages with the ratchet wheels 30. And said “U” shape frontal portion is further provided with protruding piece 62 on two outer side of said “U” shape frontal portion that engages with said side panels for positioning and guiding said control pulling plate 60 movement. In operation, when the user pushes handle 40, the control pulling plate 60 turns reel 20.

To operate present invention of improved belt binder structure, hold onto the handle bar 41 of the hand 40 and trigger and turn the control pulling plate 60 with a finger to allow the control pulling plate 60 to disengaged from the ratchet wheels 30 and locks with the positioning slot 111, at this state push forward the handle 40 to release the lock on belt; the user may pull out appropriate length of belt as required to tie over a load of goods.

When the use is done tightening the load of goods with the belt, hold onto the handle bar 40 on the handle 40 and push down on the handle 40, which turns the ratchet wheels 30 and reel 20 simultaneously clockwise a bit and at the same time pushes out the control pulling plate 60 a bit to release it from locking with the position slot 111. Once the control pulling plate 60 is unlocked the user may pull the handle 40 (along with the control pulling plate 60) back to it's original position and repeat the process of triggering and turning the control pulling plate 60, push forward and then downward on the handle 40 to tighten the belt.

It should be appreciated that the present invention is capable of a variety of embodiments and various modifications by those skilled in the art, and all such variations or changes shall be embraced within the scope of the following claims.

1. An improved belt binder structure comprising:
a binder body, said binder body is provided with a flat base and two sides of said flat base are bended upward to form enclosure side panels; said enclosure side panels are provided with a reel hole and a positioning slot;
a reel installed onto said binder body by inserting it into said reel holes on said enclosure side panels; a portion of the installed reel protrudes out from said reel holes of said enclosure side panels;
two ratchet wheels, each of said ratchet wheel slides over and fixed onto the two end sides of said reel;
a handle installed over the binder body; said handle comprises a removable handle bar and two side panels; said side panels connects with the two side ends of said reel;
a locking plate installed in between said enclosure side panels of said binder body and to the rear of said reel; said locking plate engages with said ratchet wheel; and;
a turnable control pulling plate installed in between said side panels of said handle; the frontal portion of said control pulling plate forms a pair of locking portions that locks with said positioning slot and tip of said locking portions engage with said ratchet wheels.

2. The improved belt binder structure as claimed in claim 1 wherein, the front portion of said control pulling plate recesses inward to form a “U” shape frontal portion and said locking portions situate on the inner sides of said “U” shape frontal portion; and said “U” shape frontal portion is further provided with protruding piece on two outer side of said “U” shape frontal portion that engages with said side panels for positioning and guiding said control pulling plate movement.

3. The improved belt binder structure as claimed in claim 1 or 2 wherein, said handle is characterized by that said removable handle bar insertable into said side panels.

4. The improved belt hinder structure as claimed in claim 3 wherein, said side panels are provided with removable decorating panels.
